(19) United States
(12) Patent Application Publication
(10) Pub. No.: US 2010/0126488 A1
(43) Pub. Date: May 27, 2010

(54) METHOD AND APPARATUS FOR CUTTING WAFERS BY WIRE SAWING

(76) Inventors: Abhaya Kumar Bakshi, Westford, MA (US); Bhaskar Chandra Panigrahi, Southborough, MA (US)

Correspondence Address: GLOBAL IP SERVICES, PLLC, 10 CRESTWOOD LANE, NASHUA, NH, 03062, US

(21) Appl. No.: 12/343,499

(22) Filed: Dec. 24, 2008

Related U.S. Application Data
(60) Provisional application No. 61/117,603, filed on Nov. 25, 2008.

(51) Int. Cl. B28D 1/08; B24B 57/02

(52) U.S. Cl. 125/16.02; 125/35; 125/21; 451/60; 451/446; 451/296

(57) ABSTRACT

A method and apparatus of cutting wafers by wire sawing is disclosed. In one embodiment, a wire sawing apparatus includes a horizontal ingot feeding wire slicing apparatus which includes a vertical wire web, in which sawing wires of the vertical wire web are located substantially in a vertical plane and move in a substantially vertical direction, a top outlet located in top position with respect to a work piece for applying fluid during sawing, and a chute located substantially below the work piece for receiving the fluid, wherein the work piece is impelled against the vertical wire web by horizontal movement and the fluid moves in a vertical direction against and into the work piece. The wire sawing apparatus further includes a frame for holding the horizontal ingot feeding wire slicing apparatus, and a control panel for operating the wire sawing apparatus.

### RELATED APPLICATIONS

This application claims priority under 35 U.S.C. 119 to U.S. Provisional Application No. 61/117603, entitled “METHOD AND APPARATUS FOR CUTTING WAFERS BY WIRE SAWING” by Cambridge Energy Resources, Inc., filed on Nov. 25, 2008, which is incorporated herein its entirety by reference.

### FIELD OF TECHNOLOGY

The present invention relates generally to wire sawing and more particularly relates to method and apparatus of cutting wafers by wire sawing.

### BACKGROUND

Wire saws are extensively used to slice silicon for solar and micro-electronics applications. The wire saws are also used for slicing a variety of other materials including sapphire, gallium arsenide (GaAs), indium phosphide (InP), silicon carbide (SiC), glass, lithium tantalate (LiTaO₃) Z-cut crystals, lithium niobate (LiNbO₃), lithium triborate (LiB₃O₅), quartz crystals, ceramics like aluminum nitride (ALN) and lead zirconate titanate (PZT), magnetic materials/parts, optical parts and the like material. The wire saws typically use a 120-180 micron diameter steel wire, which is several hundred kilometers long (FIG. 1). The wire is wound around a supply spool 110, a set of rollers called “wire guides” 130 to make a bed of parallel moving wire, often called “wire web” 140, and a take-up spool 120 as shown in FIG. 1. The wire guides 130 have equally spaced grooves on their outer surface to control spacing between the wires as it goes around the wire guides 130. The distance between the grooves, called pitch, eventually decides thickness of the wafers.

The work piece or the ingot 150, which needs to be sliced, is first glued to a plate 160 and then mounted on the wire saw. Then the ingot 150 is pressed with a vertical motion (top to bottom or bottom to top) against the horizontally moving wire web 140. The wire travels at a speed of about 15 meters/sec (or even higher) during slicing of wafers. Abrasive slurry, mainly made up of silicon carbide grains and a lubricant (e.g., polyethylene glycol or mineral oil), is introduced over the wire web 140. The abrasive slurry 210 coats the wire and travels to the cutting zone as shown in FIG. 2.

Also, it can be seen in FIG. 2 that, the abrasive slurry 210 tends to flow downwardly and away from the slicing zone, thereby significantly reducing the efficiency of slicing during the sawing operation. Further, it can be seen that a significant amount of abrasive slurry 210 is wasted by not being used in the slicing operation as the abrasive slurry 210 tends to flow downwardly and away from the cutting zone. Furthermore, it can be seen in FIG. 2 that, the abrasive slurry 210 flows perpendicular to direction of the horizontally moving wire web 140 (FIG. 2). Also, it can be seen in FIG. 2 that, majority of the abrasive slurry 210 does not pass through the ingot 150 and instead falls to the ground (bottom) of the wire saw. Further, in the conventional system using low viscosity slurries, risk of particles separating out of the abrasive slurry 210 is high.

Typically, slicing is achieved by slowly pushing the ingot 150 against the wire web 140. Slicing is completed when the ingot 150 completely passes through the wire web 140. At this point, the wafer stack which is held to the plate 160 is slowly pulled out of the wire web 140. Then, the stack of wafers is removed from the wire saw and taken for cleaning.

The wafers are then cleaned immediately with water and other solvents after slicing is completed to remove the abrasive slurry 210, otherwise the abrasive slurry 210 may stain the wafers thereby making them unusable in downstream processes. Then the glue which holds the wafer to the plate 160 is softened by heating and wafers are removed individually (mostly manually) for further cleaning and processing.

### SUMMARY

A method and apparatus of cutting wafers by wire sawing is disclosed. According to one aspect of the present invention, a wire sawing apparatus includes a horizontal ingot feeding wire slicing apparatus for slicing wafers, a frame for holding the horizontal ingot feeding wire slicing apparatus, and a control panel for operating the wire sawing apparatus.

Further, the horizontal ingot feeding wire slicing apparatus includes a vertical wire web such that sawing wires of the vertical wire web are located substantially in a vertical plane and move in a substantially vertical direction, at least one top outlet for applying fluid during sawing, wherein the at least one top outlet being located in a top position with respect to at least one work piece, such that the fluid (e.g., an abrasive slurry) flows in a substantially downward vertical direction under a gravitational force, and at least one chute for removing the fluid, such that the at least one chute is located substantially below the at least one work piece for receiving the fluid, in which the at least one work piece is impelled against the vertical wire web by movement in a horizontal direction, and in which the fluid is applied to the top of the at least one work piece and moves in a vertical direction against and into the at least one work piece for slicing wafers.

The horizontal ingot feeding wire slicing apparatus further includes at least two wire guide cylinders, such that the sawing wires are stretched between the at least two wire guide cylinders and held substantially in the vertical plane by a defining interval between the sawing wires, a tension control unit for controlling tension of the sawing wires, a support table for carrying the at least one work piece to be sliced, and a power driver for driving the at least two wire guide cylinders.

According to another aspect of the present invention, a method for producing wafers includes cutting a work piece including at least one ingot by impelling the work piece into a substantially vertical wire web, such that sawing wires of the substantially vertical wire web are located in a substantially vertical plane and move in a substantially vertical direction and in which the work piece is moved in a substantially horizontal direction into the substantially vertical wire web, and contacting the moving work piece for slicing wafers separately with a fluid including an abrasive slurry, such that the fluid flows in a substantially downward vertical direction under a gravitational force and such that moving the work piece and contacting with the fluid slices the wafers secured at one end to a plate.

The methods and apparatuses disclosed herein may be implemented in any means for achieving various aspects. Other features will be apparent from the accompanying drawings and from the detailed description that follows.

### BRIEF DESCRIPTION OF THE DRAWINGS

Embodiments of the present invention are illustrated by way of an example and not limited to the figures of the accompanying drawings, in which like references indicate similar elements and in which:

FIG. 1 illustrates schematics of a conventional wire saw;

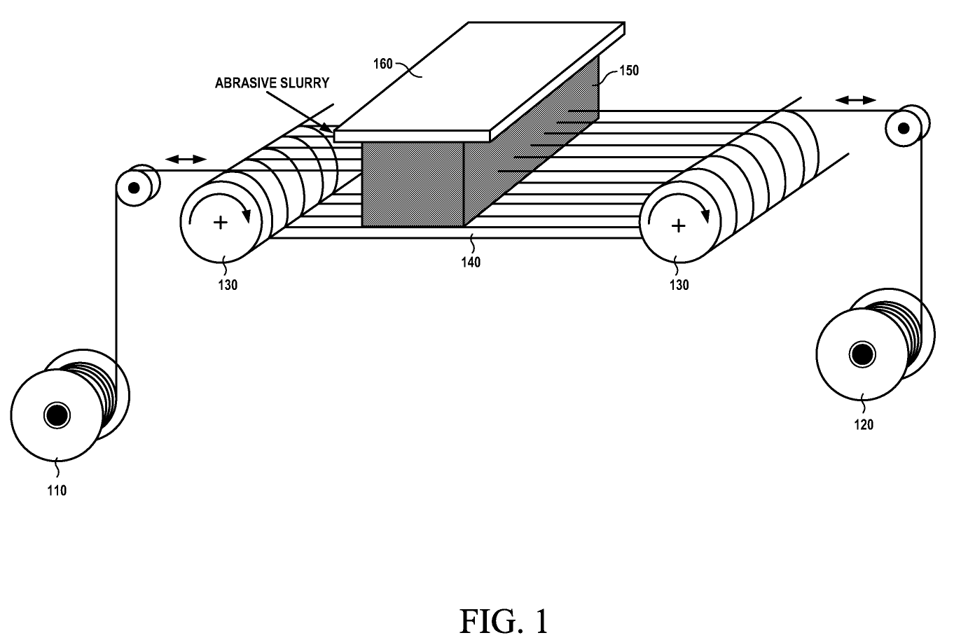

FIG. 2 illustrates schematics of the slurry flow in the conventional wire saw through the wafers during cutting;

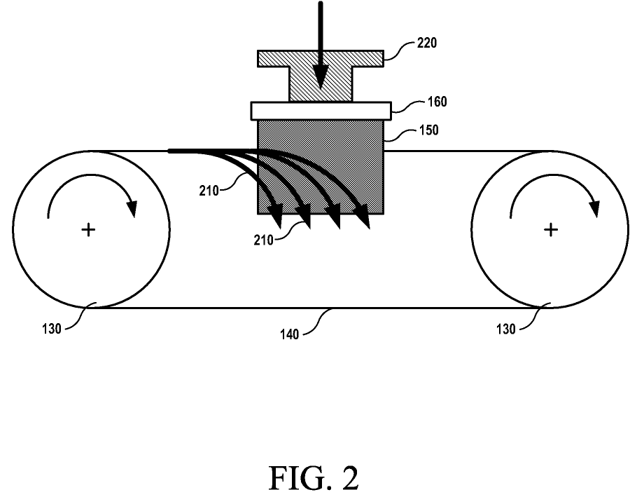

FIG. 3 illustrates an exemplary method of work piece preparation prior to loading on a wire saw apparatus, according to an embodiment of the present invention;

FIG. 4 illustrates an exemplary horizontal ingot feeding wire slicing apparatus and a method thereof, according to an embodiment of the present invention;

FIG. 5 illustrates an exemplary horizontal ingot feeding wire slicing apparatus, wherein the sliced wafers are removed after slicing process, according to an embodiment of the present invention; and

FIG. 6 illustrates an exemplary wire sawing apparatus, according to an embodiment of the present invention.

Other features of the present embodiments will be apparent from the accompanying drawings and from the detailed description that follows.

### DETAILED DESCRIPTION

A method and apparatus for cutting wafers by wire sawing is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms “slicing”, “sawing”, “watering”, and “cutting” are used interchangeably throughout the document.

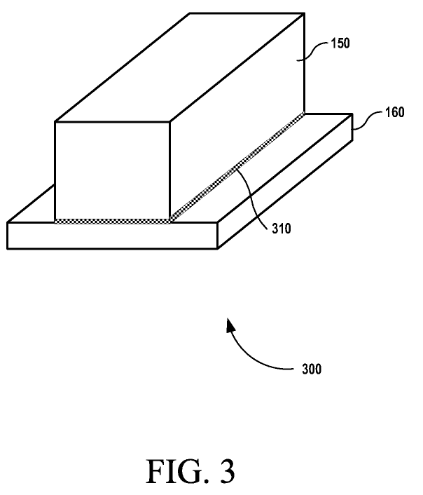

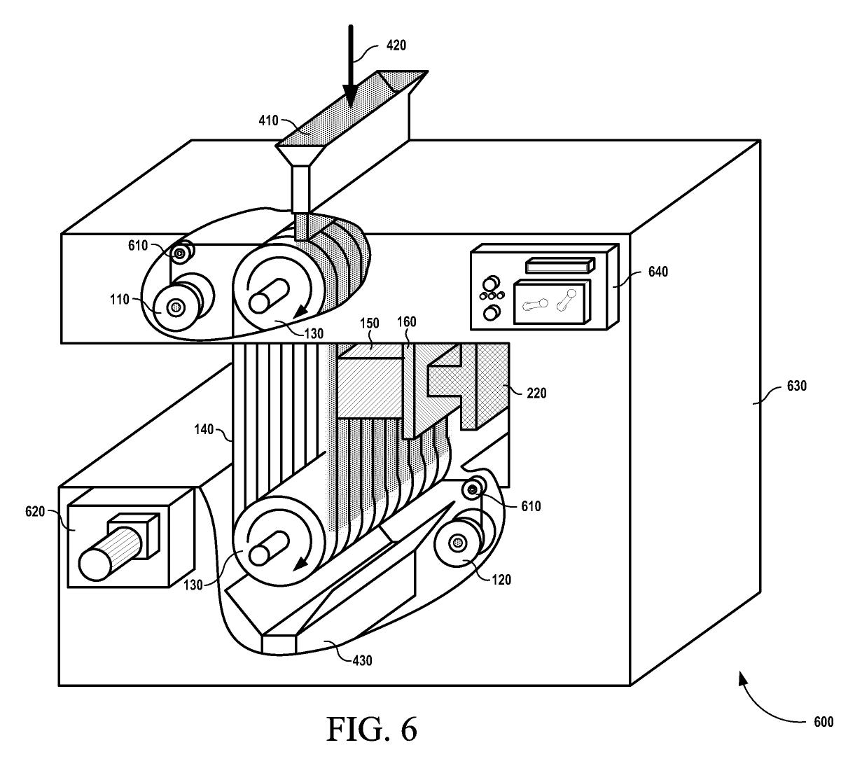

FIG. 3 illustrates an exemplary method 300 of work piece preparation prior to loading on a wire saw apparatus (e.g., the wire saw apparatus 600 of FIG. 6), according to an embodiment of the present invention. As shown in FIG. 3, a work piece 150 is attached to a plate 160. For example, the work piece 150 may be silicon (Si), sapphire, gallium arsenide (GaAs), indium phosphide (InP), silicon carbide (SiC), lithium tantalate (LiTaO₃) Z-cut crystals, lithium niobate (LiNbO₃), lithium triborate (LiB₃O₅), quartz crystals, ceramics like aluminum nitride (ALN) and lead zirconate titanate (PZT), magnetic materials/parts, optical parts, or glass. Further, the work piece 150 may be mono-crystalline silicon (i.e., the work piece 150 grown from a single crystal) or multi-crystalline silicon. The plate 160 may be glass, ceramic, plastic, silicon or a like material.

In one exemplary implementation, the work piece 150 is attached to the plate 160 by glue 310. It is appreciated that gluing of the work piece 150 to the plate 160 ensures secured holding of sliced wafers to the plate 160. One skilled in the art can envision that the work piece 150 can be attached to the plate 160 using other techniques that are well known in the art.

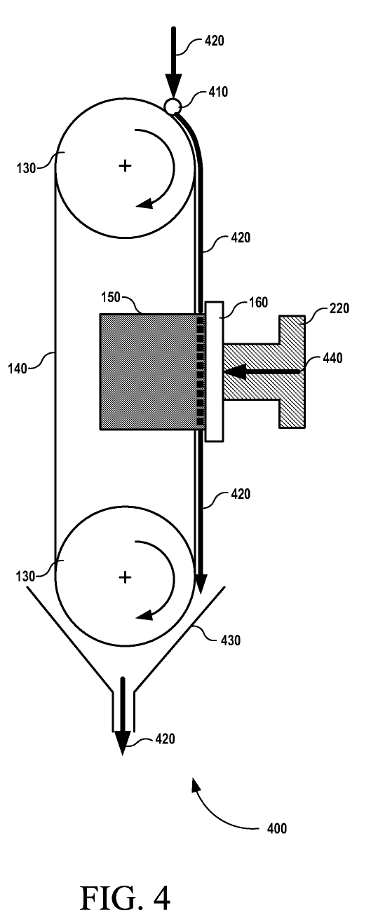

FIG. 4 illustrates an exemplary horizontal ingot feeding wire slicing apparatus 400 and a method thereof, according to an embodiment of the present invention. As shown in FIG. 4, the horizontal ingot feeding wire slicing apparatus 400 includes a vertical wire web 140, a top outlet 410 and a chute 430.

It can be seen in FIG. 4 that, sawing wires of the vertical wire web 140 are located in a vertical plane and move in a substantially vertical direction. In some embodiments, the sawing wires of the vertical wire web 140 are formed by spirally winding between two wire guides cylinders 130. In these embodiments, the sawing wires are stretched between the two wire guide cylinders 130 and held substantially in the vertical plane by a defining interval between the sawing wires.

Further, as shown in FIG. 4, the work piece 150 (e.g., including one or more ingots) to be sliced by the horizontal ingot feeding wire slicing apparatus 400 is attached to the plate 160. In one exemplary implementation, the work piece 150 is attached to the plate 160 by glue 310 (e.g., as shown in FIG. 3). It is appreciated that, the plate 160 is located substantially laterally on a side of the vertical wire web 140 in a substantially vertical plane that is parallel to the plane of the vertical wire web 140. As shown in FIG. 4, a support table 220 of the horizontal ingot feeding wire slicing apparatus 400 carries the work piece 150 attached to the plate 160.

In operation, the work piece 150 is impelled against the vertical wire web 140 by movement in a horizontal direction (e.g., as shown by reference numeral 440) for slicing wafers. In one embodiment, the work piece 150 including a plurality of ingots is impelled substantially simultaneously to the vertical wire web 140. In an alternate embodiment, the work piece 150 including the plurality of ingots is impelled substantially serially to the vertical wire web 140. It is appreciated that the sawing wires of the vertical wire web 140 are adapted to move in a substantially vertical alternating or continuous direction while impelled against the work piece 150.

Further, in accordance with the above-described embodiments, the top outlet 410 is located in a top position with respect to the work piece 150 for applying fluid 420 during the sawing operation. For example, the fluid 420 is an abrasive slurry. In one exemplary implementation, the top outlet 410 is located and oriented to substantially flow the fluid 420 over the top of the work piece 150 as the work piece 150 is impelled against the vertical wire web 140 and during the slicing of the wafers. It can be seen in FIG. 4 that, the fluid 420 flows in a substantially downward vertical direction under a gravitational force.

Further, as shown in FIG. 4, the chute 430 is located substantially below the work piece 150 for removing the fluid 420. In one exemplary implementation, the fluid 420 is applied to the top of the work piece 150 and flows in a vertical direction against and into the work piece 150 for slicing the wafers, which is finally received by the chute 430. Moreover, depending on the size, relative value, and speed of motion of the work piece 150, the fluid 420 can be separately collected and re-used, or can be collected together and discarded.

According to the one or more embodiments described above, the method for producing wafers using the above-described horizontal ingot feeding wire slicing apparatus 400 include cutting the work piece 150 including one or more ingots by impelling the work piece 150 substantially into the vertical wire web 140 and contacting the moving work piece 150 for slicing wafers separately with the fluid 420. Further, moving the ingot and contacting the work piece 150 with the fluid 420 slices the wafers secured at one end to the plate 160.

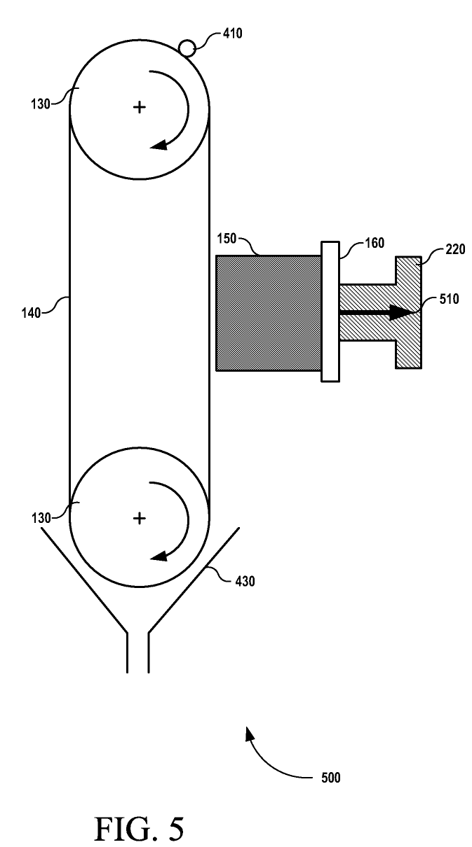

FIG. 5 illustrates an exemplary horizontal ingot feeding wire slicing apparatus 500, wherein the sliced wafers are removed after slicing process, according to an embodiment of the present invention. The slicing process is completed when the work piece 150 completely passes through the vertical wire web 140.

As shown in FIG. 5, the sliced wafers secured to the plate 160 are slowly pulled out (indicated by a reference numeral 510) of the vertical wire web 140. It is appreciated that thickness of the sliced wafers are separated from each other by sawing gaps due to the defining interval between the sawing wires. In one example embodiment, the thickness of each sliced wafer is less than about 800 microns, less than about 500 microns, less than about 300 microns, less than about 200 microns, less than about 150 microns, less than about 100 microns, or less than about 50 microns. Further, stack of wafers are removed from the horizontal ingot feeding wire slicing apparatus 500 and taken for cleaning and processing, which is well known to a person skilled in the art.

FIG. 6 illustrates an exemplary wire sawing apparatus 600, according to an embodiment of the present invention. Particularly, FIG. 6 illustrates the wire sawing apparatus 600 which includes the horizontal ingot feeding wire slicing apparatus 400. It is appreciated that the horizontal ingot feeding wire slicing apparatus 400 is a retrofittable device that is designed to be integrated into the wire sawing apparatus 600. One can envision that, the horizontal ingot feeding wire slicing apparatus 400 can be integrated into any existing wire sawing apparatus. As shown in FIG. 6, the horizontal ingot feeding wire slicing apparatus 400 includes a supply spool 110, a take-up spool 120, the wire guide cylinders 130, the vertical wire web 140, the top outlet 410, the chute 430, a tension control unit 610, the support table 220 and a power driver 620.

As shown in FIG. 6, the sawing wires of the vertical wire web 140 are located substantially in a vertical plane and move in a substantially vertical direction. Also, as shown in FIG. 6, the sawing wires of the vertical wire web 140 are stretched between the wire guide cylinders 130. It can be seen in FIG. 6 that, the sawing wires of the vertical wire web 140 are spirally wound around the supply spool 110, the two wire guide cylinders 130 and the take-up spool 120.

Further, as shown in FIG. 6, the top outlet 410 is located in a top position with respect to the work piece 150. According to an embodiment of the present invention, the top outlet 410 applies the fluid 420 during sawing, where the fluid flows in a substantially downward vertical direction under a gravitational force. Further, it can be seen in FIG. 6 that, the top outlet 410 is located and oriented such that the fluid 420 substantially flows over the top of the work piece 150 as the work piece 150 is impelled against the vertical wire web 140 and during slicing of wafers. Further, it can be seen in FIG. 6 that, the chute 430 is located substantially below the work piece 150 for removing the fluid 420 used in the slicing process.

According to the above-described embodiments, the tension control unit 610 controls tension of the sawing wires, the support table 220 carries the work piece 150 to be sliced and the power driver 620 drives the wire guide cylinders 130. It is appreciated that the support table 220 along with other elements form a horizontal ingot feeding device in the horizontal ingot feeding wire slicing apparatus 400. In one exemplary implementation, the horizontal ingot feeding device is arranged to maintain, during slicing, partially or completely sliced wafers substantially parallel to each other and such that the width of the sawing gaps is held substantially constant during slicing of the wafers. Further, the horizontal ingot feeding wire slicing apparatus 400 and a method thereof is described in greater detail with respect to FIG. 4. The wire sawing apparatus 600 also includes a frame 630 for holding the horizontal ingot feeding wire slicing apparatus 400 and a control panel 640 that may be attached to the frame 630 for operating the wire sawing apparatus 400, according to the example embodiment illustrated in FIG. 6.

With reference to the above-described wafer cutting technique, a plurality of zones is envisioned with respect to the work piece 150 and the vertical wire web 140, in terms of placement of sources of the fluid 420, and collection of the fluid 420. Thus, there is a “pre-saw” zone in which the fluid 420 is contacted to the work piece 150.

An embodiment of the present invention, designed to solve the hydrodynamic stress problem without breakage of wafers, provides a design of the wire sawing apparatus in which the work piece is impelled against the vertical wire web by movement in a horizontal direction. Unlike conventional wire saws, in which the fluid is fed over a horizontal wire web, in the present method and apparatus, the fluid is fed downward across the vertical wire web (as illustrated in FIG. 4). As a result, the fluid migrates into the work piece by advantageously responding to the gravitational force as well as the drag force of the fast moving vertical wire web. This arrangement forces the fluid to pass through the cutting zone of the work piece.

An advantage of gravity assisted vertical fluid flow in the design of the wire sawing apparatus herein is that, particles do not settle out of the fluid. Rather the entire fluid is forced to pass through the cutting zone of the work piece. Use of the vertical wire sawing apparatus further enables use of low viscosity fluids, which imparts lower stress on the wafers. Further, by use of the above-described wire sawing apparatus, a larger number of abrasive particles are introduced into the cutting zone, and efficiency of the cutting process is thereby significantly increased. Further, the consumable cost of the slicing process is decreased.

A skilled person will recognize that many suitable designs of the systems and processes may be substituted for or used in addition to the configurations described above. It should be understood that the implementation of other variations and modifications of the embodiments of the invention and its various aspects will be apparent to one ordinarily skilled in the art, and that the invention is not limited by the exemplary embodiments described herein and in the claims. Therefore, it is contemplated to cover the present embodiments of the invention and any and all modifications, variations, or equivalents that fall within the true spirit and scope of the basic underlying principles disclosed and claimed herein. The contents of all references cited are incorporated herein by reference in their entireties.

What is claimed is:

1. A wire sawing apparatus, comprising:
a horizontal ingot feeding wire slicing apparatus, wherein the horizontal ingot feeding wire slicing apparatus comprises:
a vertical wire web, wherein sawing wires of the vertical wire web are located substantially in a vertical plane and move in a substantially vertical direction;
at least one top outlet for applying fluid during sawing, wherein the at least one top outlet being located in a top position with respect to at least one work piece, wherein the fluid flows in a substantially downward vertical direction under a gravitational force and wherein the fluid comprises an abrasive slurry;
at least one chute for removing the fluid, wherein the at least one chute is located substantially below the at least one work piece for receiving the fluid, wherein the at least one work piece is impelled against the vertical wire web by movement in a horizontal direction, and wherein the fluid is applied to the top of the at least one work piece and the fluid moves in a vertical direction against and into the at least one work piece for slicing wafers;
at least two wire guide cylinders, wherein the sawing wires are stretched between the at least two wire guide cylinders and held substantially in the vertical plane by a defining interval between the sawing wires;
a tension control unit for controlling tension of the sawing wires;
a support table for carrying the at least one work piece to be sliced;
a power driver for driving the at least two wire guide cylinders;
a frame for holding the horizontal ingot feeding wire slicing apparatus; and
a control panel for operating the wire sawing apparatus.

2. The apparatus according to claim 1, wherein the at least one top outlet is located and oriented to substantially flow the fluid over the top of the at least one work piece as the work piece is impelled against the vertical wire web and during slicing of the wafers.

3. The apparatus according to claim 1, wherein the at least one work piece is attached to a plate, and the plate is located substantially laterally on a side of the vertical wire web in a substantially vertical plane that is parallel to the plane of the vertical wire web, wherein during the horizontal movement of the at least one work piece against the vertical wire web, the sliced wafers are secured to the plate, and wherein the plate comprises glass, silicon, ceramic, plastic or a like material.

4. The apparatus according to claim 3, wherein the at least one work piece is attached to the plate by glue.

5. The apparatus according to claim 1, wherein the at least one work piece comprises a plurality of ingots.

6. The apparatus according to claim 5, wherein the plurality of ingots is impelled substantially simultaneously to the vertical wire web.

7. The apparatus according to claim 5, wherein the plurality of ingots is impelled substantially serially to the vertical wire web.

8. The apparatus according to claim 1, wherein the at least one work piece comprises silicon (Si), sapphire, gallium arsenide (GaAs), indium phosphide (InP), silicon carbide (SiC), lithium tantalate (LiTaO₃) Z-cut crystals, lithium niobate (LiNbO₃), lithium triborate (LiB₃O₅), quartz crystals, ceramics like aluminum nitride (ALN) and lead zirconate titanate (PZT), magnetic materials/parts, optical parts or glass.

9. The apparatus according to claim 8, wherein the silicon is selected from the group consisting of mono-crystalline and multi-crystalline.

10. A horizontal ingot feeding wire slicing apparatus, comprising:
a vertical wire web, wherein sawing wires of the vertical wire web are located substantially in a vertical plane and move in a substantially vertical direction;
at least one top outlet for applying fluid during sawing, wherein the at least one top outlet being located in a top position with respect to at least one work piece, wherein the fluid flows in a substantially downward vertical direction under a gravitational force and wherein the fluid comprises an abrasive slurry; and
at least one chute for removing the fluid, wherein the at least one chute is located substantially below the at least one work piece for receiving the fluid; wherein the at least one work piece is impelled against the vertical wire web by movement in a horizontal direction, and wherein the fluid is applied to the top of the at least one work piece and the fluid moves in a vertical direction against and into the at least one work piece for slicing wafers.

11. The slicing apparatus of claim 10, further comprising:
at least two wire guide cylinders, wherein the sawing wires are stretched between the at least two wire guide cylinders and held substantially in the vertical plane by a defining interval between the sawing wires;
a tension control unit for controlling the tension of the sawing wires;
a support table for carrying the at least one work piece to be sliced; and
a power driver for driving the at least two wire guide cylinders.

12. The slicing apparatus of claim 10, wherein the sawing wires are stretched between at least two wire guide cylinders and held in the substantially vertical plane by the defining interval between the sawing wires, thereby thickness of the sliced wafers separated from each other by sawing gaps, wherein the sawing wires are adapted to move in a substantially vertical alternating or continuous direction while impelled against the at least one work piece.

13. The slicing apparatus of claim 10, further comprising a horizontal ingot feeding device arranged to maintain, during slicing, partially or completely sliced wafers substantially parallel to each other and such that the width of the sawing gaps is held substantially constant during slicing of the wafers.

14. The slicing apparatus of claim 12, wherein the sawing wires of the vertical wire web are formed by spirally winding between the at least two wire guide cylinders.

15. The slicing apparatus of claim 11, wherein the horizontal ingot feeding wire slicing apparatus is a retrofittable device that is designed to be integrated into a wire sawing apparatus.

16. A method for producing wafers, the method comprising:
cutting a work piece comprising at least one ingot by impelling the work piece into a substantially vertical wire web, wherein sawing wires of the substantially vertical wire web are located in a substantially vertical plane and move in a substantially vertical direction, and wherein the work piece is moved in a substantially horizontal direction into the substantially vertical wire web; and
contacting the moving work piece for slicing wafers separately with at least one fluid comprising an abrasive slurry, wherein the fluid flows in a substantially downward vertical direction under a gravitational force and wherein moving the work piece and contacting with the fluid slices the wafers secured at one end to a plate.

17. The method according to claim 16, wherein thickness of each sliced wafer is less than about 800 microns, less that about 500 microns, less than about 300 microns, less than about 200 microns, less than about 150 microns, less than about 100 microns, or less than about 50 microns.

18. The method according to claim 16, wherein the plate comprises glass, ceramic, plastic, silicon or a like material and the work piece is glued to the plate.

19. The method according to claim 16, wherein the work piece comprises silicon (Si), sapphire, gallium arsenide (GaAs), indium phosphide (InP), silicon carbide (SiC), lithium tantalate (LiTaO₃) Z-cut crystals, lithium niobate (LiNbO₃), lithium triborate (LiB₃O₅), quartz crystals, ceramics like aluminum nitride (ALN) and lead zirconate titanate (PZT), magnetic materials/parts, optical parts or glass.
